(19) United States
(12) Patent Application Publication
(10) Pub. No.: US 2026/0309431 A1
(43) Pub. Date: Oct. 8, 2026

(54) THERMAL ENERGY STORAGE

(71) Applicant: MAGALDI POWER S.P.A., Roma RM (IT)

(72) Inventors: Mario MAGALDI, Salerno SA (IT); Rocco SORRENTI, Salerno SA (IT)

(73) Assignee: MAGALDI POWER S.P.A., Roma RM (IT)

(21) Appl. No.: 19/484,033

(22) PCT Filed: May 7, 2024
(86) PCT No.: PCT/IB2024/054438

§ 371 Date: Nov. 13, 2025

(30) Foreign Application Priority Data
May 17, 2023 (IT) 102023000009972

(51) Int. Cl. F28D 20/00; F28D 13/00; F28F 21/08

(52) U.S. Cl. CPC F28D 20/0056; F28D 13/00; F28F 21/083; F28F 21/087; F28D 2020/0086

(57) ABSTRACT

A thermal energy storage and exchange device having a metal external casing, a fluidizable bed of particles, metal separation means peripheral to the bed of particles and distant from the walls of the external casing which creates a hollow volume which is filled with an amount of stationary particles, and means for heating the fluidized bed. The metal separation means allows the tightness of the fluidization air and the section of stationary particles, nor fluidized nor aerated, acts as thermal insulation.

### TECHNICAL FIELD OF THE INVENTION

The present invention relates to a thermal energy storage and release device based upon a fluidizable bed of particles.

The invention also provides an energy production plant including such device.

### ANALYSIS OF THE PRIOR ART AND OF ITS DRAWBACKS

The prior art is using thermal storage and exchange devices based upon beds of fluidized particles by adding air. In such devices, the fluidized bed, for example consisting of sand particles, acts as thermal carrier, by receiving and storing the thermal energy coming from a source, for example of solar nature, and releasing such energy, in contextual or deferred manner, to an operating fluid or other thermal exchange means.

Devices of this type are described, for example, in WO2011/135501 and WO2017/021832 in the name of the same applicant.

Some types of plants for the production of thermal and/or electric energy can include one or more of said thermal energy storage or exchange devices, which act as modules.

In the fluidized bed devices of known art, the thermal containment of the bed of particles is implemented by means of a casing which includes insulating material and refractory material placed in direct contact with the fluidized bed of particles. This involves considerable costs both of the used materials and the related laying.

Said refractory materials are generally resistant to abrasion and to high temperatures and they have dilation joints arranged in areas selected depending upon the area extension and upon the expected operation temperature. However, at the latter, fissures or cracks may generate due to the hydrostatic push of the bed of particles, the start/stop cycles of fluidization and operating temperatures higher than 600 °C.

Said fissures or cracks, among other things, determine a loss in fluidization air, by preventing a correct fluidization, by reducing the thermal exchange performances and by not allowing an effective motion of the particles.

The interventions for restoring the dilation joints of the refractory material, or of the whole refractory itself, require to shutdown the plant and to empty the bed of particles, with related costs and consequent thermal energy and production losses.

Therefore, the effectiveness and the performances of the fluidized bed thermal energy storage and release devices of known art can be improved.

### SUMMARY OF THE INVENTION

The technical problem placed and solved by the present invention, then, is to implement a thermal energy storage and release device allowing to obviate the drawbacks mentioned above with reference to the known art, by improving the effectiveness and/or performances thereof.

Such problem is solved by a device according to claim 1.

Preferred features of the device of the invention are set forth in the depending claims. The device according to the invention is equipped with a thermal insulation system based upon a section of still granular particles, that is of a stationary bed. The latter is separated from a second fluidizable bed through partition means implemented by a metal sheet arranged peripherally to the fluidizable bed itself and distant from the walls of an external casing so as to create a hollow volume which indeed receives the stationary bed. In such arrangement, the metal sheet acts as separation means between the fluidizable bed of particles and the section of static particles and the latter, since it is not fluidized nor aerated, acts, as said, as thermal insulation.

The external casing can be made of metal carpentry.

The amount and then the thickness of still particles can be sized, in particular, depending upon the low thermal conductivity, the operating temperature of the device and the temperature of the external environment.

In an embodiment, the fluidizable bed of particles is heated by means of elements immersed in the bed itself. In particular, such elements can be electric means, for example resistors.

Said heating means can be, or include, thermal exchange elements of different type, or the thermal energy, associated to a solar radiation concentrated by a suitable optical system, can be transferred to the bed of particles.

The temperature in the internal area of the device, at the fluidizable bed, can reach very high values, typically higher than 600 °C.

As said, the section of still particles, arranged peripherally to the separation means made of metal sheet and outside it, even thanks to its low equivalent thermal conductivity, which mainly depends upon the degree of vacuum among the particles, and typically equal to about 0.3 w/(m K), allows to insulate the central area housing the fluidized bed and not to transfer the thermal energy towards outside. The temperature of the external casing of the device then can be slightly higher than the room temperature.

The fluidization air is sent from the bottom to the area of the fluidizable bed and it remains confined by the separation means made of metal sheet.

In particular, the separation means made of metal sheet is connected to a bottom, or floor, of the device, preferably welded thereon, and it does not allow the fluidization air to escape, then resulting to be tight for such air.

The separation means is made of a material resistant to the high temperatures of the fluidized bed, and it preferably has a profile with cross waves which allows the expansion thereof in horizontal direction. The expansion in longitudinal, that is vertical, direction can take place freely upwards.

In a preferred configuration, the profile of the metal sheet is then corrugated.

In a preferred configuration, the fluidization means escapes from the base or bottom of the device by determining, during operation, a fixed head of particles underlying the fluidized bed of particles. Such fixed head, analogously to the peripheral static section of particles, is not aerated nor fluidized and it allows to obtain a thermal insulation towards the bottom of the device, by further preserving the connection thereof with the separation means made of sheet.

The present invention allows to remove the functional problems found in the known thermal insulation systems which provide the combined use of refractory and insulating sheaths.

Moreover, in its embodiments the invention allows a perfect tightness of the fluidization air and the consequent correct motion of the fluidized bed of particles.

The device then results to be reliable and it has high storage and thermal exchange efficiency.

The proposed device stores thermal energy, for example to produce flexibly electric and/or thermal energy. It can constitute a multipliable module of plants for the production of electric and thermal energy serving communities and industrial plants.

Other advantages, features and use modes of the present invention will result evident from the following detailed description of some embodiments, shown by way of example and not for limiting purposes.

### BRIEF DESCRIPTION OF THE FIGURES

The figures of the enclosed drawings will be referred to, wherein:

FIG. 1 relates to a preferred embodiment of a thermal energy storage and release device according to the invention, by showing a schematic representation thereof in plan view;

FIG. 2 shows a front section of the device of FIG. 1 performed according to the line A-A of the latter figure;

FIG. 3 shows a lateral section of the device of FIG. 1 performed according to the line B-B of the latter figure;

FIGS. 4A and 4B relate to a preferred embodiment of a corrugated metal sheet used in the device of FIG. 1, by showing respectively a schematic perspective view and a cross section view.

The sizes represented in the above-mentioned figures are to be meant as purely exemplifying and not necessarily shown in proportion.

### DETAILED DESCRIPTION OF PREFERRED EMBODIMENTS

Various embodiments and variants of the invention will be described hereinafter and this with reference to the above-mentioned figures.

Analogous components are designated in the different figures with the same numeral reference.

In the following detailed description, additional embodiments and variants with respect to embodiments and variants already treated in the same description will be illustrated limitedly to the differences with respect to what already illustrated.

Moreover, the different embodiments and variants described hereinafter are likely to be used in combination, where compatible.

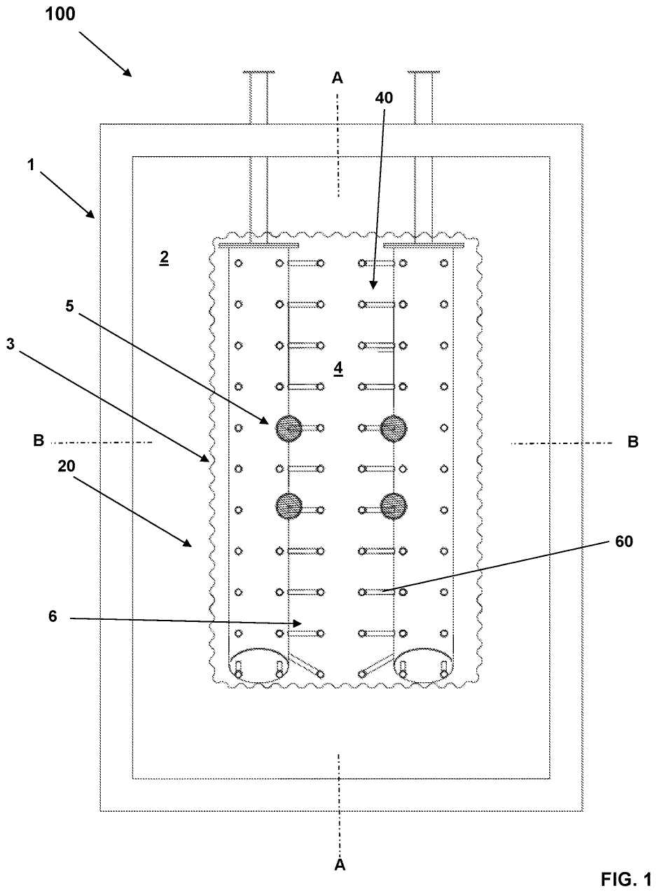

By firstly referring to FIGS. 1 to 3, a thermal energy storage and exchange device according to a preferred embodiment of the invention is designated as a whole with 100.

The device 100 comprises a gas-tight and solid particle-tight external casing 1, advantageous made of metal carpentry.

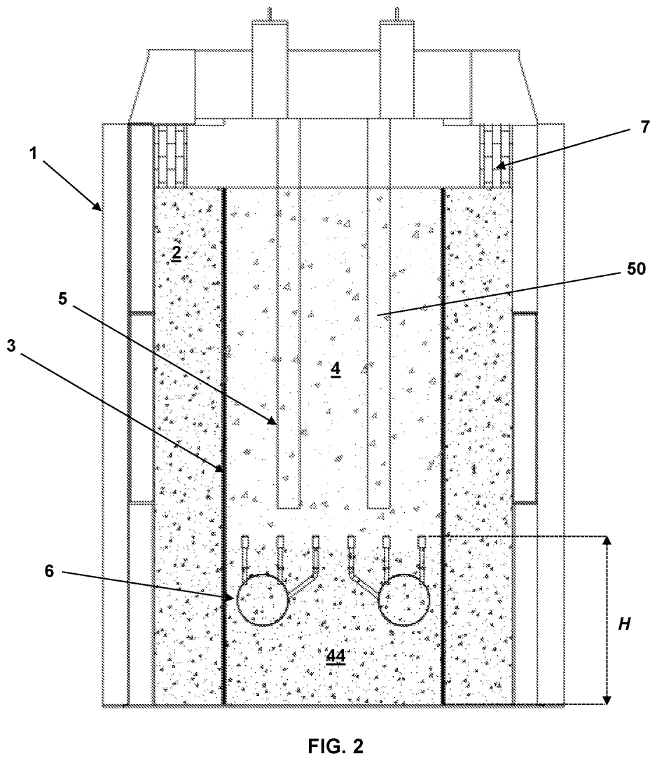

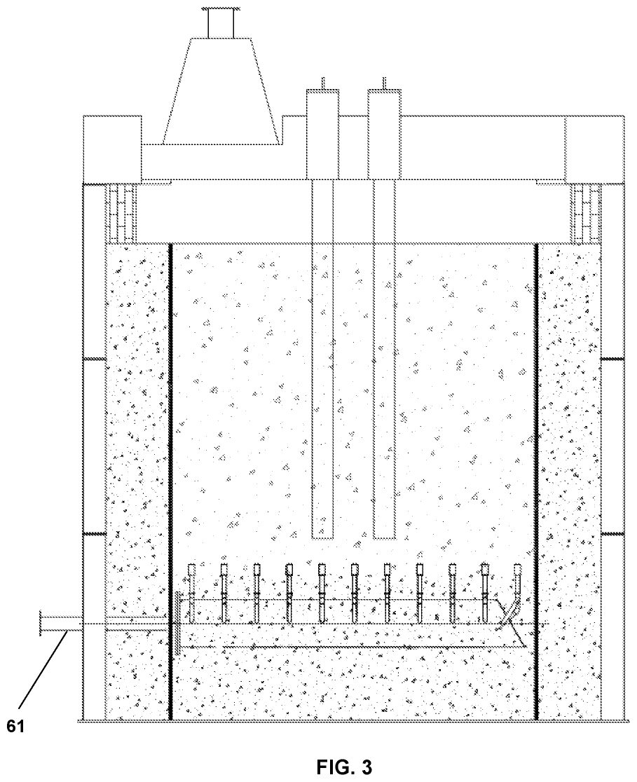

In the present example the external casing 1 circumscribes and defines all internal components of the device. Advantageously, it has square plan. As shown in FIGS. 2 and 3, it can have an internal coating or coat 7 made of insulating material, extending for example at an upper peripheral portion of the device 100.

Within the casing 1 internal partition means 3 is housed and circumscribed, in particular in form of a skirt or wall extending according to a closed perimeter. The partition means 3 defines an internal containment compartment or volume 40. In the present example the internal compartment 40 has substantially parallelepiped-like shape.

In the present example the partition means 3 too has quadrangular plan, in particular extending according to a closed rectangular perimeter. Advantageously, the partition means is arranged centred, and then spatially equidistant in plan view, from the external casing 1, as it can be seen from FIG. 1.

Between the external casing 1 and the internal partition means 3 an external containment compartment or volume 20 remains delimited, circumscribed to the internal containment compartment 40. Then, the external compartment 20, in the present example, has substantially frame-like, in particular quadrangular, shape in plan view.

Within the internal containment compartment 40 a fluidizable bed of solid particles 4 is received.

Such particles can be silica sand or other granular material resistant to high temperature and preferably they have regular shape, preferably spheroidal and preferably with sizes in the order of 100-300 micron.

Within the external containment compartment 20 a stationary, that is not fluidized, bed of solid particles 2 is received. The particles of the stationary bed 2 can have the same nature of that of those of the fluidizable bed 4.

The stationary bed of particles 2 acts as bearing for the thermal insulation between the fluidizable bed of particles 4 and the external casing 1 and then the environment outside the device 100.

The device 100 also comprises fluidization means 6 of the fluidizable bed of particles 4, indeed configured to supply a fluidization gas, in particular air, inside the bed itself.

In the present example the fluidization means 6 comprises a plurality of nozzles 60 for delivering fluidization gas. Advantageously, the latter are arranged at a floor of the internal containment compartment 40, in particular in two or more parallel rows.

Advantageously, the nozzles 60 are arranged, in plan view, at a central part of the fluidizable bed of particles 4, as it can be seen from FIG. 1.

The fluidization means 6 can be configured to determine a differentiated fluidization of the fluidizable bed of particles 4, in particular with a higher particle velocity at a central part of the bed, that is, in the present example, the part in which the nozzles 60 are positioned. Based upon this variant, or other alternative implementations, the peripheral portion of the bed 4 adjacent to the partition means 3 is less hot and/or less dynamic than the central one and then the possible thermal and/or mechanical wear of the partition means 3 is limited.

Moreover, in a preferred embodiment the fluidization means 6 is configured to deliver the fluidization gas at a predetermined height of the fluidizable bed of particles 4, so as to leave a lower head of not fluidized particles 44.

In this way, a thermal insulation of the floor of the device 100 towards the external environment is guaranteed, to the advantage even of the system sustainability. In FIG. 2, the height of this head is exemplified and identified with a quota H.

The internal partition means 3 is made of metal sheet and configured as gas-tight and particle-tight, by preventing the passage of fluidization gas and particles of the fluidizable bed of particles 4 in the external containment compartment 20.

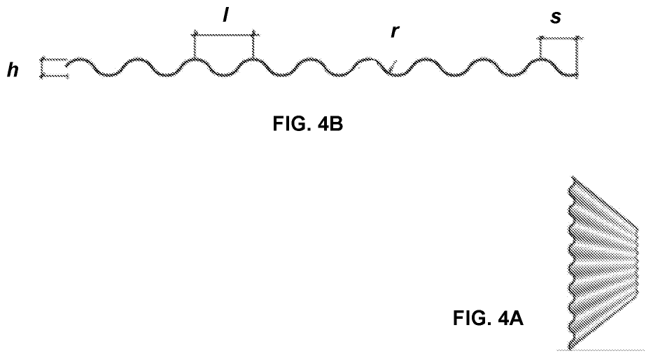

With reference also to FIGS. 4A and 4B, the internal partition means 3 is made of preferably corrugated metal sheet.

For operating temperatures within 700 °C, the material constituting the sheet can be stainless steel, for higher values Nickel-based alloys can be used.

Preferably, the metal sheet has a thickness equal to or less than about 1 mm.

In a preferred embodiment, thereto FIG. 4 relates, the corrugated metal sheet has a corrugation profile with transversal, in particular substantially sinusoidal, bends.

Preferably, the corrugation profile has a wave pitch included in a range of about 100-200 mm.

Preferably, the corrugation profile has a wave height h included in a range of about 10-40 mm.

Preferably, the corrugation profile has a radius of curvature r comprised in a range of about 20-50 mm.

The device 100 further comprises means 5 for heating the fluidizable bed 4.

In the present example, the heating means 5 is immersed in the fluidizable bed of particles 4 and/or lapped by the latter when fluidized, in such a way as to release thermal energy.

In a preferred embodiment, the heating means 5 comprises electrical resistor means 50, in particular in the form of one or more bars inserted longitudinally into the fluidizable bed of particles 4.

One or more devices as the one described above can be used in an electrical or thermal energy production plant or even exploited in industrial plants of other nature, for example desalters.

The present invention has been sofar described with reference to preferred embodiments. It is to be meant that other embodiments belonging to the same inventive core may exist, as defined by the protective scope of the herebelow reported claims.

1. A thermal energy storage and exchange device comprising:
a gas-tight external casing;
internal partition means delimiting an internal containment compartment, wherein said external casing is arranged externally circumscribed to said internal partition means in such a way that an external containment compartment is delimited between them, also circumscribed to said internal containment compartment;
a fluidizable bed of solid particles received within said internal containment compartment;
a non-fluidized stationary bed of solid particles received within said external containment compartment and configured to act as thermal insulation means; and
means for heating said fluidizable bed,
wherein said internal partition means is made of metal sheet and configured as gas-tight and particle-tight, by preventing the passage of fluidization gas and particles of the fluidizable bed of particles in said external containment compartment.

2. The device according to claim 1, wherein said external casing is made of metal carpentry.

3. The device according to claim 1, further comprising means for the fluidization of said fluidizable bed of particles configured to supply a fluidization gas, in particular air, through said fluidizable bed of particles.

4. The device according to claim 1, wherein said fluidization means comprises a plurality of nozzles for delivering fluidization gas.

5. The device according to claim 4, wherein said delivery nozzles are arranged at a floor of said internal containment compartment.

6. The device according to claim 3, wherein said delivery nozzles are arranged in two or more parallel rows.

7. The device according to claim 3, wherein said delivery nozzles are arranged, in plan view, at a central part of said fluidizable bed of particles.

8. The device according to claim 2, wherein said fluidization means is configured to determine a differentiated fluidization of said fluidizable bed of particles, in particular with a higher particle velocity at a central part of said fluidizable bed of particles.

9. The device according to claim 2, wherein said fluidization means is configured to deliver the fluidization gas to a predetermined height (H) of said fluidizable bed of particles, so as to leave a lower head of non-fluidized particles.

10. The device according to claim 1, having a head of non-fluidized particles arranged below said fluidizable bed of particles.

11. The device according to claim 1, wherein said internal partition means is arranged centred with respect to said external casing.

12. The device according to claim 1, wherein said external casing and said internal partition means have both a quadrangular shape in plan view.

13. The device according to claim 1, wherein said internal partition means has a profile with bends to allow transversal expansion.

14. The device according to claim 1, wherein said internal partition means is made of corrugated profile metal sheet.

15. The device according to claim 13, wherein said profile is substantially sinusoidal.

16. The device according to claim 15, wherein said profile has a wave pitch (l) included in a range of about 100-200 mm.

17. The device according to claim 15, wherein said profile has a wave height (h) included in a range of about 10-40 mm.

18. The device according to claim 1, claims, wherein said internal partition means is made of metal sheet having a thickness equal to or less than approximately 1 mm.

19. The device according to claim 1, wherein said internal partition means is made of stainless-steel metal sheet or a nickel-based alloy.

20. The device according to claim 1, wherein said heating means is immersed in said fluidizable bed of particles e/o lapped by the latter when fluidized in such a way as to release thermal energy.

21. The device according to claim 1, wherein said heating means comprises electrical resistor means, in particular in the form of one or more bars inserted longitudinally into said fluidizable bed of particles.

22. An electrical or thermal energy production plant, comprising one or more devices according to claim 1.
